(19) United States
(12) Patent Application Publication
(10) Pub. No.: US 2009/0280986 A1
(43) Pub. Date: Nov. 12, 2009

(54) FT NAPHTHA AND FT DIESEL AS SOLVENTS OR CARRIERS FOR PESTICIDES AND/OR HERBICIDES

(75) Inventor: Richard O. Sheppard, Los Angeles, CA (US)

Correspondence Address: CONLEY ROSE, P.C.;David A. Rose, P. O. BOX 3267, HOUSTON, TX, 77253-3267, US

(73) Assignee: RENTECH, INC., Los Angeles, CA (US)

(21) Appl. No.: 12/437,981

(22) Filed: May 8, 2009

Related U.S. Application Data
(60) Provisional application No. 61/051,876, filed on May 9, 2008.

(51) Int. Cl. A01N 25/02; A01P 13/00; A01P 15/00

(52) U.S. Cl. 504/362; 514/789

(57) ABSTRACT

A pesticide or herbicide formulation comprising an effective amount of a pesticide or herbicide in a carrier or solvent fluid, wherein the carrier or solvent fluid comprises a Fischer-Tropsch hydrocarbon produced via Fischer-Tropsch conversion of synthesis gas. A method of producing a pesticide or herbicide formulation by combining an amount of an herbicide or pesticide and a biodegradable solvent to form a pesticide or herbicide solution. A method of producing a pesticide or herbicide formulation by converting synthesis gas into Fischer-Tropsch products in the presence of a Fischer-Tropsch catalyst and combining at least one Fischer-Tropsch product with a pesticide or herbicide to create the formulation.

### STATEMENT REGARDING FEDERALLY SPONSORED RESEARCH OR DEVELOPMENT

This application claims the benefit under 35 U.S.C. §119(e) of U.S. Provisional Patent Application No. 61/051,876 filed May 9, 2008, the disclosure of which is hereby incorporated herein by reference in its entirety.

### BACKGROUND OF THE INVENTION

1. Field of the Invention

The present invention relates generally to pesticide and/or herbicide formulations, methods of making pesticide/herbicide formulations, and methods of treating objects using the new formulations.

2. Background of the Invention

Conventionally, petroleum derived kerosene and diesel which are not biodegradable are utilized as carriers and solvents for herbicides/pesticides. Concerns about environmental affects of the incorporation of such petroleum-derived oils in herbicides/pesticides have led to a search for environmentally-friendly compositions and methods of controlling pests and/or undesirable biological growth.

For example, the mutagenicity index is one measure of potential carcinogenicity and values less than two are generally taken to indicate a low probability of such carcinogenic behavior. Typical commercial aromatic oils have naphthalene contents in excess of 100 wppm. These particular types of aromatic compounds plus other polynuclear aromatics may lead to environmental concerns when the use is environmentally sensitive, e.g., as carrier or solvent oils in pesticide formulations. Such aromatic oils are thus undesirable in environmentally-sensitive applications such as agricultural formulations.

Accordingly, there is a need for pesticide and/or herbicide carriers and/or solvents which are more environmentally-friendly than petroleum-derived products. The carriers and/or solvents may have favorable mutagenicity indices, low odor, low water solubility, low vapor pressure, good color and/or be sprayable.

### SUMMARY OF THE INVENTION

Herein disclosed is a pesticide or herbicide formulation comprising an effective amount of a pesticide or herbicide in a carrier or solvent fluid, said carrier or solvent fluid comprising a Fischer-Tropsch hydrocarbon produced via Fischer-Tropsch conversion of synthesis gas. The pesticide or herbicide may be an agricultural formulation. The pesticide or herbicide may be an oil-soluble pesticide or herbicide. The formulation may be in a concentrated form.

The pesticide or herbicide may further comprise an inert solid carrier impregnated with a solution comprising the pesticide or herbicide and the FT hydrocarbon. The solid carrier may be selected from the group consisting of ground natural minerals, ground synthetic minerals, synthetic granules of inorganic and organic meals, granules of organic material, synthetic polymeric materials, and combinations thereof.

In embodiments, the formulation is in the form of an emulsifiable concentrate, may comprise the effective amount of the pesticide or herbicide in FT hydrocarbon liquid carrier, and may further comprise an emulsifier. The emulsifier may be selected from the group consisting of surfactants. In embodiments, the FT hydrocarbon comprises FT naphtha, FT diesel, FT kerosene or a combination thereof.

In embodiments, the Fischer-Tropsch hydrocarbon was produced with a precipitated iron catalyst comprising a weight ratio of potassium to iron in the range of from about 0.005 and about 0.015 and a weight ratio of copper to iron in the range of from about 0.005 and about 0.05. The Fischer-Tropsch catalyst may further comprise a structural promoter. The structural promoter may comprise silica.

Also disclosed herein is a method of producing a pesticide or herbicide formulation, the method comprising combining an amount of an herbicide or pesticide and a biodegradable solvent to form a pesticide or herbicide solution. In embodiments, the biodegradable solvent is a product of Fischer-Tropsch conversion of synthesis gas. In embodiments, the biodegradable solvent comprises Fischer-Tropsch diesel. In embodiments, the biodegradable solvent comprises Fischer-Tropsch naphtha. In embodiments, the biodegradable solvent comprises Fischer-Tropsch kerosene.

The method of producing a pesticide or herbicide formulation may further comprise impregnating a solid carrier with the solution. In embodiments, the solid carrier is selected from the group consisting of ground natural minerals, ground synthetic minerals, synthetic granules of inorganic and organic meals, granules of organic material, synthetic polymeric materials, and combinations thereof. The amount of pesticide or herbicide may be a concentrated amount and the solution may further comprise an emulsifier, wherein the concentrated amount is an amount greater than an effective application amount of the pesticide or the herbicide. In embodiments, the emulsifier is selected from the group consisting of surfactants. The biodegradable solvent may be a product of Fischer-Tropsch conversion of synthesis gas in the presence of a precipitated iron catalyst. The precipitated iron catalyst may comprise a weight ratio of potassium to iron in the range of from about 0.005 and about 0.015 and a weight ratio of copper to iron in the range of from about 0.005 and about 0.05.

Also disclosed is a method of producing a pesticide or herbicide formulation, the method comprising converting synthesis gas into Fischer-Tropsch products in the presence of a Fischer-Tropsch catalyst and combining at least one Fischer-Tropsch product with a pesticide or herbicide to create the formulation. In embodiments, the Fischer-Tropsch catalyst is a precipitated iron catalyst comprising a weight ratio of potassium to iron in the range of from about 0.005 and about 0.015 and a weight ratio of copper to iron in the range of from about 0.005 and about 0.05. In embodiments, the iron catalyst further comprises a structural promoter. The structural promoter may comprise silica. In embodiments, the Fischer-Tropsch catalyst is a cobalt catalyst.

The method of producing a pesticide or herbicide formulation may further comprise upgrading the Fischer-Tropsch products. The at least one Fischer-Tropsch product may comprise naphtha, diesel, kerosene, or a combination thereof.

The present invention comprises a combination of features and advantages which enable it to overcome various problems of prior devices. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of the preferred embodiment of the present invention, reference will now be made to the accompanying drawings, wherein:

FIG. 1 is a flow diagram of a method of making a pesticide/herbicide formulation according to this invention.

### NOTATION AND NOMENCLATURE

As used herein, the term “pesticide(s) or “pesticidal” includes pesticides, plant growth regulators, insecticides, acaricides, nematocides, fungicides, miticides, herbicides, algicides, bactericides, pest repellents, molluscicides, and combinations thereof, and any other substance for controlling living organisms that are deleterious to plants or animals.

As used herein, the term “agriculturally acceptable” includes agricultural, industrial, and residential use.

As used herein, the term ‘effective amount of pesticide or herbicide’ is used to refer to that amount of pesticide or herbicide that controls the presence or growth of the pest or plant being treated with the pesticide or herbicide, respectively. The ‘effective amount’ can depend on the specific pest or plant to be inhibited, the concentration of the pest or plant, and the size of the locus to be treated, for example. One of skill in the art will be able to determine, without undue experimentation, an amount of pesticide or herbicide that will be effective based on the specific conditions present, e.g., the specific plant or pest, the concentration thereof, etc.

### DETAILED DESCRIPTION

I. Overview. The present invention provides pesticide formulations, methods of making pesticide formulations, and methods of treating objects using the new formulations. The formulation herein disclosed has the advantage of being more environmentally friendly than conventional formulations comprising petroleum-derived carriers and/or solvents, because FT products, such as FT naphtha and FT diesel, are bio-friendly, e.g. biodegradable. Although the description of the invention will be made with reference to pesticides and pesticide formulations and the use thereof, it is to be understood that formulations comprising any of the pesticides mentioned in the pesticide nomenclature presented above; for example, herbicide formulations are herein considered a “pesticide formulation.” Although the present disclosure refers primarily to FT hydrocarbon products for use as a carrier of pesticides, the FT liquid hydrocarbons are equally suitable for use as solvent for emulsifiable or oil-soluble insecticides, fungicides, plant growth regulators, herbicides, etc.

According to this disclosure, FT product oils are useful as carriers/solvents in pesticide and herbicide formulations. Pesticide and herbicide formulations as disclosed herein comprise an effective amount of pesticide or herbicide in an FT product as carrier or solvent. Such pesticides and herbicides are those which are known in the art. In embodiments, the oil itself may serve as a non-selective contact herbicide for controlling undesirable weeds.

The present new pesticide formulations have been developed to control vegetation and/or organisms that are deleterious to desirable plants such as pesticide formulations employed for agriculture, horticulture, lawns and gardens, and any other situation where control of such vegetation/organisms is desired.

The object of the invention is to make herbicides and pesticides more environmentally friendly by utilizing biodegradable Fisher Tropsch product, such as FT naphtha and/or Fisher Tropsch diesel as a solvent and/or as a carrier of pesticides and/or herbicides. As mentioned hereinabove, today, the primary carrier or solvent utilized in the production and compositions of pesticide formulations are petroleum derived products, such as petroleum, diesel and kerosene, which may be harsh on the environment/non-biodegradable and/or toxic, and thus undesirable from an economic and/or environmental standpoint. The use of fuel oils may produce offensive odors and may produce off-target damage due to drift and volatility which all are detrimental to public relations and can result in claims against the user. Additionally, the use of large quantities of fuel oil may deplete the supply necessary for home and industrial heating.

According to this disclosure, a hydrocarbon product from a FT process is used as a solvent or carrier for herbicides and/or pesticides. Conventional herbicides and pesticides incorporate kerosene or diesel fuel as the carrier. The herbicide or pesticide is mixed with the petroleum-derived diesel or kerosene and the resulting formulation is spread on the plants/fields. As mentioned hereinabove, conventional diesel and kerosene have negative environmental characteristics. Conversely, FT naphtha, FT diesel, and other liquid hydrocarbons from FT are biodegradable. Such environmentally-friendly FT products can act as a carrier and/or solvent for pesticide formulations and may comprise fewer undesirable components than the conventional petroleum-derived carriers/solvents.

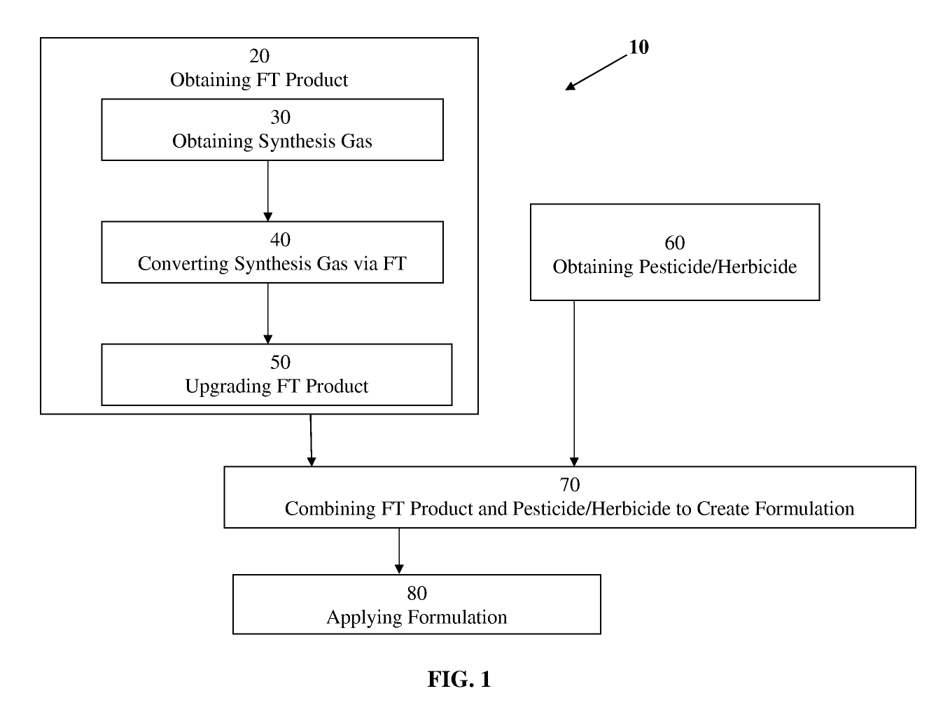

The formulation of this disclosure comprises a product of Fischer-Tropsch synthesis and at least one pesticide as described hereinabove. FIG. 1 is a flow diagram of a method 10 for producing the formulation of this disclosure. The method comprises obtaining an FT product 20, obtaining a pesticide 60, and combining the FT product with the at least one pesticide to produce the formulation 70.

Obtaining an FT product may further comprise, as shown in block 30, obtaining synthesis gas comprising hydrogen and carbon dioxide at a H₂:CO mole ratio and, as shown in block 40, converting the synthesis gas into hydrocarbons via FT reaction. Obtaining a FT product may further comprise upgrading the FT hydrocarbons 50 to produce a desired FT product.

Obtaining synthesis gas 30 may comprise gas reformation, gasification, or a combination thereof. For example, natural gas may be reformed as known in the art to produce synthesis gas. Alternatively or additionally, coal, biomass (e.g. garbage), bio-renewables (trees, plants, etc.) may be gasified in a solids gasifier to produce synthesis gas as known in the art. The synthesis gas may be purified for removal of impurities, such as acid gas and sulfur, or may be directly introduced into an FT reactor at block 40 for converting synthesis gas into hydrocarbons suitable (perhaps with further treatment as indicated in block 50) for use as a carrier/solvent for pesticide(s) according to this disclosure.

In block 40 (converting synthesis gas into hydrocarbons in a FT process), synthesis gas which comprises a mixture of hydrogen and carbon monoxide at a specific mole ratio is converted into hydrocarbons. In FT, a hydrogen and carbon monoxide-containing gas stream is introduced into a Fischer-Tropsch reactor and the synthesis gas is upgraded into a waxy hydrocarbon. Desirably, the reactor comprises a catalyst slurry.

Many different Fischer-Tropsch reactor designs can be employed to carry out FT. The preferred design is similar to that described in U.S. Pat. No. 5,504,118, which is incorporated herein by reference in its entirety for all purposes. The reactor used in the FT conversion process may be operated at from about 100 psia (689 kPa) to about 500 psia (3447 kPa) at a temperature in the range of from about 428° F. (220° C.) to about 536° F. (280° C.). Alternatively, the pressure may be in the range of from about 150 psia (1034 kPa) to about 300 psia (2068 kPa) at a temperature of from about 464° F. (240° C.) to about 500° F. (260° C.), or the pressure may be about 225 psia (1551 kPa) and the temperature may be about 482° F. (250° C.). The space velocity selected for optimal reactor conversion efficiency may be between 100 and 300 cubic feet per hour per cubic foot of expanded catalyst bed, between 200 and 270 cubic feet per hour per cubic foot of expanded bed, or about 240 cubic feet per hour, per cubic foot of expanded catalyst bed. The reactor diameter may be selected to give a feed superficial velocity (actual volumetric flow rate of feed gases divided by empty reactor cross-sectional area) between approximately 0.33 to 0.66 feet per second (0.1 to 0.2 meters per second). These conditions may serve to increase the height of the selected catalyst bed between 30% and 40% over the height of the bed without flow. In addition, the slurry may be an efficient heat transfer medium for the exothermic reactions taking place.

During FT conversion, the percent by weight of the selected iron catalyst in the reactor slurry (for example, in a slurry bubble column reactor, or SBCR) may be in the range of from 5 to 15 percent by weight of iron in the slurry, between 7.5 and 12.5 percent by weight or about 10 percent by weight of the slurry.

FT Catalyst. As mentioned hereinabove, the FT reactor comprises a FT catalyst. In embodiments, the FT catalyst is an iron catalyst. In embodiments, the FT catalyst is a cobalt catalyst. In embodiments, an iron FT catalyst is formed according to the description in U.S. Pat. No. 5,504,118 and U.S. Provisional Patent No. 60/955,142. The catalyst may be made using elemental iron and optionally copper as starting materials.

The first step in the preparation of the raw catalyst may be dissolution of the metals in nitric acid to form a mixture of ferrous nitrate, ferric nitrate and optionally cupric or at least one other metal nitrate in appropriate proportions. The acid solution may comprise a certain ratio of ferric to ferrous iron. In embodiments, ferrous/ferric nitrate solution having a desired ratio of ferrous to ferric iron in the acid solution is formed. Specifically, in embodiments, a stable ferrous nitrate solution is formed, a ferric nitrate solution is formed, and appropriate amounts of the stable ferrous nitrate and ferric nitrate solutions are combined to yield a stable ferric/ferrous nitrate solution having the desired ratio of ferric to ferrous iron. In embodiments, the nitric acid is about 17 weight % nitric acid.

In embodiments, the next step in the FT catalyst formation is precipitation of a catalyst precursor from the nitrate solution using a precipitating agent (base). Production of the iron FT catalyst may comprise addition of the acid solution to the base, addition of the base solution to an acid solution, or a combination thereof. In embodiments, the precipitating agent (base) is selected from the group consisting of NH₄OH, (NH₄)₂CO₃, NH₄HCO₃, NaOH, Na₂CO₃, NaHCO₃, KOH, K₂CO₃, KHCO₃, and combinations thereof. In specific embodiments, the precipitating agent comprises sodium carbonate. In some embodiments, the base comprises ammonium hydroxide.

As mentioned hereinabove, base may be added to nitrate solution, or nitrate solution added to base. In embodiments, base is added to hot nitrate solution at ambient temperature. The amount of base may be such that the pH of the solution reaches about 7.4. At this point, metals may precipitate out as oxides, hydroxides, carbonates, or a combination thereof. The mixture may then be cooled (e.g., to about 80° F.) and the final pH adjusted. The final pH may be adjusted to about 7.2.

Mixing ferrous and ferric nitrate solution and stabilizing the solution before the precipitation step may take significant time and effort. Alternative routes may be used to overcome these problems. These routes may comprise: (1) co-feeding ferrous nitrate and precipitation agent onto ferric nitrate solution to produce precipitate; (2) co-feeding ferric nitrate and precipitation agent onto ferrous nitrate solution to precipitate a precipitate; and (3) precipitating ferrous nitrate, ferric nitrate separately using precipitation agent(s) and combining them. Combination of the separate precipitates may be performed prior to a washing/filtration step. Catalyst precipitation may further comprise separate precipitation of copper and mixing of the copper precipitate with the iron precipitates of (1), (2), or (3).

Following precipitation, the catalyst precursor may be washed using high quality water which is preferably free of chlorine. The slurry may be pumped from the precipitation vessel into a holding tank located upstream of a vacuum drum filter. The catalyst precursor may be allowed to settle in the holding tank and a clear layer of concentrated solution may form above the solids. This layer may be drawn off before the slurry is washed and filtered. A vacuum drum filter fitted with water spray bars may be used for washing the catalyst precursor and concentrating the slurry. The electrical conductivity of the filtrate may be monitored to ensure complete washing of the catalyst precursor has been effected.

Following washing, the washed precipitate may be alkalized by, for example, the addition of potassium carbonate. In embodiments, alkalization is performed prior to spray drying in order to adjust the Fe:K ratio to the desired value. In embodiments, alkalization is performed prior to spray drying in order to provide the desired Fe:K ratio. For example, in embodiments, following washing of catalyst precursor, potassium carbonate is added in an amount appropriate for the quantity of iron contained in the batch. Potassium may serve as a promoter for chain growth and may also maintain the catalyst in iron carbide form. Adding more than appropriate amount of potassium may cause formation of more oxygenated products which may oxidize the catalyst. In embodiments, potassium carbonate is added to the slurry after washing is completed and prior to spray drying. Potassium carbonate may be dissolved in a small amount of water and this solution mixed thoroughly with the catalyst precursor slurry to uniformly distribute the potassium. In embodiments, the weight percent of solid catalyst material in the slurry at this point is a value of between about 8 to about 12.

In embodiments, as described in U.S. Provisional Patent Application No. 61/028,635 filed Feb. 14, 2008 and entitled, “Strengthened Iron Catalyst for Slurry Reactors,” the iron FT catalyst may further comprise a structural support (such as a binder) incorporated after precipitation of the catalyst precursor and/or a support material coprecipitated with iron. The support material may serve to increase the structural integrity of the catalyst. In embodiments, the iron catalyst of the present disclosure comprises coprecipitated material selected from iron, silica, magnesium, copper, aluminum, and combinations thereof. Alternatively, or additionally, potassium silicate binder, colloidal silica, and/or tetraethyl ortho silicate (TEOS) may be added to a precipitated catalyst to increase the strength thereof.

In embodiments, the structural promoter is incorporated into the iron catalyst by coprecipitation. The iron catalyst precursor may be prepared by co-precipitation of copper, silicon, magnesium, and aluminum with iron to provide an FT catalyst that exhibits high activity, selectivity, and stability.

The method of forming iron catalyst may comprise dissolving predetermined quantities of copper or at least one metalloid or metal other than iron in nitric acid to form a solution comprising cupric nitrate and/or other nitrates and precipitating a catalyst precursor comprising metal oxides by the addition of sufficient precipitating agent to the solution formed. The metal oxide comprises iron oxide selected from the group consisting of hydrous iron oxides and precipitated iron oxide, and may comprise oxides of copper, and other metal oxides. Additionally or alternatively, copper or at least one other metal or metalloid may be added following precipitation, as, for example, copper nitrate solution.

In embodiments, the method of producing the catalyst further comprises co-precipitation of at least one structural promoter with the iron of the iron catalyst. In embodiments, the catalyst comprises more than about 50 wt % of oxides including iron oxides and other oxides. In embodiments, the metal of the mixed oxides is selected from silicon, magnesium, aluminum, copper, iron, and combinations thereof. In embodiments, the catalyst comprises up to 50 wt % oxides selected from oxides of copper, magnesium, silicon, aluminum and combinations thereof.

In some embodiments, the catalyst comprises oxides of magnesium, copper, and aluminum in addition to iron oxides, and is formed by coprecipitation of iron with magnesium, copper, and aluminum from a nitrate solution or solutions thereof.

In some embodiments, the catalyst is formed by coprecipitation with magnesium. In embodiments, magnesium is coprecipitated from magnesium nitrate. In some embodiments, the iron catalyst is formed by coprecipitation with copper. In embodiments, copper is coprecipitated from copper nitrate. In embodiments, the iron catalyst is formed by coprecipitation with aluminum. In embodiments, aluminum is precipitated from aluminum nitrate. In some embodiments, the iron catalyst is formed by coprecipitation from aluminum nitrate. In embodiments, the iron catalyst is formed by coprecipitation of iron with magnesium, silica, aluminum, copper, or a combination thereof.

In embodiments, iron catalyst is formed by coprecipitation of iron, copper, magnesium and aluminum. In embodiments, the ratio of magnesium to aluminum atoms in the catalyst and/or in the pre-precipitation mixture is in the range of from about 0.4 to about 0.6. In embodiments, the ratio of magnesium to aluminum is about 0.5.

As discussed hereinabove, the iron FT catalyst may comprise a structural promoter. In embodiments, the structural promoter comprises tetraethyl orthosilicate, TEOS. Catalyst comprising structural promoter of silica may be formed by coprecipitating the catalyst from a solution comprising TEOS structural promoter.

In embodiments, a structural promoter is added to a conventional precipitated catalyst subsequent precipitation of the catalyst precursor comprising iron hydroxides, iron oxides and/or iron carbonates. As mentioned above, in embodiments, structural promoter is coprecipitated with the catalyst material. In embodiments, additional structural promoter (e.g. binder) is added following the precipitation of the catalyst material.

In embodiments structural promoter comprising silicon is added to a catalyst precipitate, the precipitate comprising iron phases. The iron phases may be selected from iron hydroxides, iron carbonates, iron oxides, and combinations thereof. The structural promoter may comprise potassium silicate aqueous solution, which will be referred to herein as liquid potassium silicate. In embodiments, the liquid structural promoter comprises tetraethyl ortho silicate, TEOS, or potassium silicate and is added such that the catalyst has a silica content of from about 1 wt. % to about 2.2 wt. %.

As mentioned above, in embodiments, various amounts of liquid potassium silicate (K₂SiO₂) are added to a raw precipitated catalyst. In embodiments, precipitated iron catalyst is impregnated by mixing thoroughly with various amounts of aqueous potassium silicate. In embodiments, the precipitate is heated to 125° C. at the rate of 2° C./min, and held at this temperature for 12 h, and then ramped to 350° C. at the rate of 1°/min, and calcined at this temperature for 16 h prior to impregnation with aqueous potassium silicate solution. In other embodiments, liquid potassium silicate is added to iron precipitate prior to spray drying of the impregnated precipitate. The iron catalyst may comprise SiO₂ concentrations in the range of from about 1.0 wt % to about 2.2 wt %. The potassium silicate solution may comprise SiO₂/K₂O in a desired ratio for the production of catalyst having the desired composition.

In embodiments, a structural promoter is added to the catalyst slurry. In embodiments, a silicon-containing binder comprising potassium silicate, colloidal silica, TEOS, or a combination thereof is added to the catalyst slurry.

In embodiments, potassium carbonate and structural promoter are added simultaneously to precipitated catalyst precursor comprising iron, iron hydroxide, iron oxide, and/or iron carbonate. In embodiments, the structural promoter comprises silica in colloidal form. In embodiments, the silica is silica sol. In some embodiments, the silica sol is selected from TMA LUDOX, LUDOX, LUDOX AS-30 and polysilicic acid (available from Sigma Aldrich, St. Louis, Mo.).

In some embodiments, the structural promoter is silica and the liquid structural promoter is added to the catalyst precursor (precipitated catalyst material) following the addition of potassium carbonate promoter. In embodiments, structural promoter (potassium silicate or TEOS; about 1 wt % to 3 wt %) is added to the precipitate comprising mixed metal oxides, hydroxides, and/or carbonates.

A spray dryer may be used to remove most of the water from the precipitated catalyst precursor and at the same time to produce roughly spherical precipitated catalyst particles having diameters in the range of 40 to 100 microns, prior to the addition of structural promoter comprising silicate via incipient wetness technique. In embodiments, a structural promoter is added to the catalyst precursor to yield a promoted mixture prior to drying as described above.

The catalyst may be heated in air (for example, to about 600° F.) to remove residual moisture and to stabilize the precipitated catalyst. In embodiments, this step is carried out in a fluidized bed which is heated electrically.

Following drying, the dried precipitated catalyst precursor may be calcined. In embodiments, calcination is carried out at a temperature in the range of from about 250° C. to about 450° C. In some embodiments, calcination is carried out at a temperature in the range of from about 300° C. to about 400° C. In some embodiments, calcination is performed at a temperature of about 350° C. In embodiments, silicate structural binder is added to a calcined precipitated catalyst.

The desired iron catalyst may be activated prior to use in an FT process, as known to those of skill in the art. In certain embodiments, the iron catalyst is activated in situ. Many different activating procedures for promoted iron Fischer-Tropsch catalysts have been described in the literature.

In embodiments, the selected iron catalyst is pre-treated in hydrogen. In embodiments, the iron catalyst is pretreated with a gas comprising carbon monoxide. In embodiments, the iron catalyst is pre-treated in synthesis gas. In embodiments, pre-treatment occurs at preselected conditions of temperature and pressure. In embodiments, these pre-selected conditions of temperature encompass a temperature of from about 250° C. to about 300° C. In embodiments, these pre-selected conditions of pressure encompass a pressure of from about 5 atm. to about 10 atm.

In embodiments, hydrogen-rich synthesis gas is used in lieu of an inert gas for maintaining the iron catalyst in suspension while the slurry is being heated to approximately 200° C. At this point, the synthesis gas is replaced by an inert gas (nitrogen or carbon dioxide) until the activation temperature has been attained at which time activation is carried out using synthesis gas.

It has been reported in U.S. Pat. No. 5,504,118 that the presence of a large amount (20%) by volume of nitrogen in the synthesis gas used for pretreatment of a precipitated catalyst had no detrimental effect on the activation procedure. In embodiments, activation of the desired iron catalyst occurs in the presence of about 20% nitrogen.

In embodiments, the selected iron catalyst is activated by contacting the catalyst with a mixture of gaseous hydrogen and carbon monoxide at a temperature of from about 250° C. to 300° C., for about 0.5 to 5 hours, with a water vapor partial pressure of about 1 psia, and a hydrogen to carbon monoxide mol (or volume) ratio of about 1.3 to 1.5, the activation being effective to increase the selectivity of the activated iron catalyst in the subsequent formation of liquid hydrocarbons in a Fischer-Tropsch reaction. In embodiments, the syngas for activation has a H₂:CO mol ratio of about 1.4. In embodiments, activation in syngas occurs for a time period up to 6 hours. In embodiments, the catalyst in wax or oil is first heated to 275° C. in H₂ and then syngas is fed for activation.

For example, the FT catalyst may be activated using a “typhoon” activation method. According to this method, in situ catalyst activation is performed by heating the catalyst to 275° C. in nitrogen, feeding syngas at a H₂:CO ratio of 1.4 once attaining a temperature of 275° C., activating at 275° C. under 140 psig pressure for 4-24 hours (depending on the space velocity).

In some embodiments, iron catalyst optionally comprising support material (e.g. MgAl₂O₄, MgAl₂O₄—SiO₂, Al₂O₃, SiO₂, SiO₂—Al₂O₃, etc.) in oil or wax is first heated to 200° C. in N₂, and then syngas is fed, and the temperature is ramped to a temperature in the range of about 285° C. to 300° C. In embodiments, the syngas used for activation has a H₂:CO ratio of about 0.7. In embodiments, the temperature is ramped from 200° C. to a temperature of from about 285° C. to about 300° C. at a ramp rate in the range of from 1° C./min to about 5° C./min.

In some embodiments, iron catalyst is activated with 100% CO.

Iron FT Catalyst Properties. In embodiments, depending on the preselected alpha, i.e., the polymerization probability desired, the precipitated iron catalyst used for obtaining FT product may have a weight ratio of potassium (e.g., as carbonate) to iron in the range of from about 0.005 and about 0.015, more preferably in the range of from 0.0075 to 0.0125, and most preferably about 0.010. Larger amounts of alkali metal promoter (e.g., potassium) cause the product distribution to shift toward the longer-chain molecules, while small amounts of alkali metal result in predominantly gaseous hydrocarbon product.

The weight ratio of copper to iron in the selected iron FT catalyst may be in the range of from about 0.005 and 0.050, more preferably in the range of from about 0.0075 and 0.0125, and most preferably about 0.010. Copper may serve as an induction promoter. In some embodiments, the weight ratio of Cu:Fe is about 1:100.

As discussed hereinabove, the desired iron FT catalyst may further comprise structural promoter to significantly reduce the breakdown of the catalyst in a SBCR (slurry bubble column reactor). The structural promoter may comprise silica, and may enhance the structural integrity during activation and operation of the catalyst. In embodiments, the catalyst comprises a mass ratio of SiO₂:Fe of less than about 1:100 when the structural promoter comprises silica and less than about 8:100 when the structural promoter comprises silica sol.

In embodiments, the at least one structural promoter is selected from oxides of metals and metalloids and combinations thereof. The structural promoter may be referred to as a binder, a support material, or a structural support.

Depending on the level of structural promoter comprising silicate and the preselected alpha, i.e. the polymerization probability desired, the weight ratio of K:Fe is from about 0.5:100 to about 6.5:100. More preferably, the weight ratio of K:Fe is from about 0.5:100 to about 2:100. In some embodiments, the weight ratio of K:Fe is about 1:100.

In some embodiments wherein the structural promoter comprises silica sol, the weight ratio of iron to potassium is in the range of from about 100:1 to about 100:5. In some embodiments, the weight ratio of iron to potassium is in the range of from about 100:2 to about 100:6. In more preferred embodiments, the weight ratio of iron to potassium is in the range of from about 100:3 to about 100:5. In some embodiments, the weight ratio of iron to potassium is in the range of from about 100:4 to about 100:5. In some preferred embodiments, the weight ratio of iron to potassium is in the range of from about 100:2 to about 100:4. In some specific embodiments, the weight ratio of iron to potassium about 100:3. In other certain embodiments, the weight ratio of iron to potassium about 100:5.

In some embodiments wherein the structural promoter comprises silica sol, the weight ratio of iron to copper is in the range of from about 100:1 to about 100:7. In some embodiments, the weight ratio of iron to copper is in the range of from about 100:1 to about 100:5. More preferably, the weight ratio of iron to copper is in the range of from about 100:2 to about 100:6. Still more preferably, the weight ratio of iron to copper is in the range of from about 100:3 to about 100:5. In some preferred embodiments, the weight ratio of iron to copper in the range of from about 100:2 to about 100:4. In other specific embodiments, the weight ratio of iron to copper about 100:5. In yet other specific embodiments, the weight ratio of iron to copper about 100:3.

Broadly, in embodiments, wherein the structural promoter is silica sol, the iron to SiO₂ weight ratio may be in the range of from about 100:1 to about 100:8; alternatively, in the range of from 100:1 to 100:7. More preferably, in some embodiments, wherein the structural promoter is silica, the iron to SiO₂ weight ratio may be in the range of from about 100:2 to about 100:6. Still more preferably, the weight ratio of iron to silica is in the range of from about 100:3 to about 100:5. In some preferred embodiments, wherein the structural promoter is silica, the iron to SiO₂ weight ratio is about 100:5. In embodiments, wherein the structural promoter is silica, the iron to SiO₂ weight ratio may be in the range of from about 100:3 to about 100:7; alternatively, in the range of from about 100:4 to about 100:6.

In some preferred embodiments, the Fe:Cu:K:SiO₂ mass ratio is about 100:4:3:5.

Under the broad operating conditions described herein, the iron catalyst particle size selected may have a large dimension of preferably between about 5 μm to 40 μm, between 10 μm to 40 μm or about 30 μm.

FT Product Upgrading. Following conversion of syngas into liquid hydrocarbon FT product via FT, the FT products may be upgraded, as shown at block 50 of FIG. 1. Upgrading of FT product 50 can be used to obtain a wide range of products. Upgrading may comprise hydrocracking, hydroisomerization, and other processes known in the art. Various products, including FT diesel, FT kerosene, and FT naphtha may be obtained from the FT product stream, and these products may be suitable for use in various pesticide formulations according to this disclosure.

Pesticide. The pesticide formulations comprise at least one pesticide. The pesticide and herbicide formulations as disclosed herein comprise an effective amount of pesticide or herbicide and an FT product as carrier or solvent. Such pesticides and herbicides are those which are known in the art. In embodiments, the oil itself may serve as a non-selective contact herbicide for controlling undesirable weeds.

Suitable pesticides/herbicides are those which are soluble in the selected FT product. By way of non-limiting example, in embodiments, the pesticide is a low-boiling pesticide. In embodiments, the pesticide comprises chlorpyrifos. Low-melting pesticides comprise pesticides having melting points in the range of from about 30° C. to 60° C. Such pesticides include, for example, chlorpyrifos (melting point 41° C.-42° C.), trifluralin (melting point 49° C.), pendimethalin (melting point 54° C.-58° C.), bifenthrin (melting point 59° C.-64° C.), cypermethrin (melting point 60° C.-80° C.), and tefluthrin (melting point 45° C.). Other pesticides with melting points outside of this range may be used in various applications.

Without wishing to be limited to these examples, the pesticide may comprise insecticides such as Imidan, produced by Stauffer Chemical Company, and Dursban, produced by Dow Chemical Company; fungicides such as Terrazole, produced by Uniroyal, Inc.; and plant growth regulators such as Embark 2S, produced by Minnesota Mining and Manufacturing Company, and Clipper, produced by ICI America, Inc.

The pesticide may comprise dithiopyr and may have an application rate of 370 or 560 grams per hectare. The pesticide may comprise an herbicidal 2,6-dinitroaniline derivative, such as trifluralin. The herbicide may be a liquid such as isopropalin, trifluralin, terbutryn, and combinations thereof.

Many other suitable pesticides and herbicides with which FT product may be used to create a pesticide/herbicide formulation are known in the art, and discussion of exemplary pesticides herein is not intended to be limiting.

Pesticide Formulation. Once a desired pesticide has been selected and obtained and/or produced 60 and FT product has been selected and obtained and/or produced 20, the FT product and the pesticide are combined to create the formulation, as indicated in block 70 of FIG. 1. Combination of the pesticide with the FT product 70 may be performed by any means known in the art, and some suitable formulations and formulation methods are presented below.

Many conventional pesticide formulations are disclosed in the art. Where such petroleum-based formulations comprise a hydrocarbon solvent or carrier, a corresponding pesticide formulation in which the petroleum-derived hydrocarbon or a portion thereof is replaced with a FT product may be formed according to this disclosure, to produce a more environmentally-favorable formulation. FT hydrocarbon product may be particularly suitable for use as a solvent for pesticides which are oil-soluble.

The pesticide formulations may be manufactured into e.g. emulsion concentrates, solutions, oil in water emulsions, wettable powders, soluble powders, suspension concentrates, dusts, granules, water dispersible granules, microcapsules, gels, emulsions, aerosols and other formulation types. The methods of manufacture may include intensive mixing and/or milling of the active ingredients with other substances, such as fillers, solvents, solid carriers, surface active compounds (surfactants), and optionally solid and/or liquid auxiliaries and/or adjuvants. The form of application such as spraying, atomizing, dispersing or pouring and the formulation composition may be chosen according to the desired objectives and the given circumstances, as known in the art.

The formulations of this disclosure comprise a pesticide and a FT product. In embodiments, a liquid FT product serves as a pesticide carrier. In embodiments, a liquid FT product serves as a solvent for the pesticide, and the formulation further comprises an inert solid carrier.

FT Product as Solvent for Solid Formulation. As mentioned above, in embodiments, the pesticide formulation of this disclosure comprises a solid carrier. In such embodiments, an FT product may be utilized as a solvent, a pesticide added to the solvent to form a solution, and the solution applied to a solid carrier (e.g. granules) which is adapted for carrying the pesticide.

Carrier. In certain aspects, therefore, the pesticide formulation of the present invention further comprises a carrier such as a solid carrier. The term “carrier” means one or more solid diluents which can be used to dissolve, disperse or diffuse the pesticide/herbicide in a composition without impairing the pesticide's effectiveness and which by itself has no significant detrimental effect on the soil, equipment, desirable plants, or agronomic environment. Carriers include, for example, ground natural minerals such as kaolins, clays, talc, chalk, quartz, attapulgite, montmorillonite, calcite, marble, pumice, sepiolite, dolomite, and diatomaceous earth; ground synthetic minerals, such as highly dispersed silicic acid, alumina, and silicates; synthetic granules of inorganic and organic meals; granules of organic material such as sawdust, coconut shells, corn cobs, and tobacco stalks; and synthetic polymeric materials. Carriers for granules may be porous material, e.g. pumice, kaolin, sepiolite, bentonite; non-sorptive carriers include calcite or sand. Additionally, a multitude of pre-granulated inorganic or organic materials may be used, such as dolomite or crushed plant residues. Other suitable carriers include, but are not limited to, silica gel, sand, gypsum, charcoal and combinations thereof. Solid carrier granules may comprise agglomerated cellulosic granules sold by Edward Lowe Industries under its trademark BIODAC.RTM. Agronomically acceptable carriers, diluents and excipients commonly utilized to form powders, dusts, granules and the like include talc, diatomaceous earth, silica, pyrophyllite, attapulgite clays and the like.

A solution of the pesticide in FT product may be applied to such a solid carrier as known in the art. Solid carriers, which may be used for dusts, wettable powders, water dispersible granules, or granules, may be mineral fillers, such as calcite, silica, talc, kaolin, montmorillonite or attapulgite. The physical properties may be improved by addition of highly dispersed silica gel or polymers. A formulation may be prepared by dissolving the pesticide in a suitable FT solvent and applying the solution to a solid carrier such as montmorillonite clay granules or the like. Another procedure which can be employed comprises simply dispersing an active ingredient (pesticide) in a dough comprising a suitable carrier, for instance damp clay, and then drying and grinding the clay to provide the formulated granules at the desired particle size.

The pesticide formulations may be conveniently formulated as concentrated compositions which are diluted prior to application, for instance by the addition of water or other suitable diluent to make a dispersion, emulsion or the like. The formulations may be in the form of wettable powders. By addition of surfactants or dispersants such powder formulations can be made readily wettable with water so that they can be converted into aqueous suspensions that are suitable for use as spray mixtures. The formulation may thus further comprise a surfactant. For example, in embodiments, the pesticide formulation comprises any of the many known surfactants, including, but not limited to, any of the sulfonated lignins, the condensed naphthalenesulfonates, the alkylbenzenesulfonates, the alkyl sulfates, as well as the nonionic surfactants such as the ethylene oxide adducts of phenols.

Method of Making Solid Formulation. Solid formulations may be formed by combining a slurry of pesticide in FT product with solid carrier particles and granulating the mixture to form larger agglomerated particles or overcoating large carrier particles with a slurry of pesticide and FT product, using a granulation method. The pesticide may be mixed in or coated using, for example, the following equipment: drum coaters, pan coaters, fluid-bed coaters, pugmill mixers, homogenizers, industry-recognized mixers such as pin mixers and screw feeders, and other industry recognized coating apparatus.

It has been disclosed that petroleum hydrocarbon spray oils in aqueous emulsion form provide carriers which enhance the effectiveness of certain herbicides. The petroleum hydrocarbon oil component of these formulations is typically a solvent refined fraction of petroleum oil composed primarily of paraffinic and naphthenic hydrocarbons. According to this disclosure, improved hydrocarbon spray oils may be formed by replacing the petroleum hydrocarbon oil fractions with FT hydrocarbon product.

FT Product as Licluid Carrier for Licluid Formulation. In embodiments, the pesticide formulation of this disclosure comprises a liquid carrier. In such embodiments, the liquid carrier comprises an FT product. In embodiments, the pesticide formulation is in the form of an emulsifiable concentrate. In such embodiments, the pesticide formations of the present invention comprise liquid carriers comprised of the FT product. In traditional pesticide formulations, liquid carriers comprise aromatic hydrocarbons, substituted naphthalenes, phthalic acid esters, such as dibutyl or dioctyl phthalate, aliphatic hydrocarbons, e.g. cyclohexane or paraffins, alcohols and glycols as well as their ethers and esters, e.g. ethanol, ethyleneglycol mono- and dimethyl ether, ketones such as cyclohexanone, strongly polar solvents such as N-methyl-2-pyrrolidone, or γ-butyrolactone, higher alkyl pyrrolidones, e.g. n-octylpyrrolidone or cyclohexylpyrrolidone, epoxidized plant oil or vegetable oil, or esters from fatty acids of vegetable oils, e.g. methylated coconut or soybean oil ester and water. Mixtures of different liquids are often used. According to this disclosure, at least a portion of the liquid carrier comprises a hydrocarbon FT product.

FT liquid hydrocarbon product may be used as solvent for pesticides/herbicides which dissolve in the formulation as the FT product is substantially immiscible with the aqueous phase of the emulsion. Such formulations are comprised of a pesticide/herbicide admixed with a liquid carrier comprising a water immiscible organic FT solvent and an emulsifying agent, so that the solution is self-emulsifying when added to water. In embodiments, the pesticide formulation thus further comprises an emulsifier.

Emulsifiers which may be employed include the common surfactants and blends of surfactants, for example the alkyl and aryl sulfonates, ethoxylated alkyl phenols, ethoxylated alkyl ethers, the nonoxynols, oxysorbics, allinols, allinates and other nonionic and anionic surfactants.

In embodiments, the FT oil product is prepared as an emulsifiable composition by adding from 0.1 to 10 parts emulsifier per 100 parts of the FT oil. Emulsifying agents may be selected from Remcopal NP 30, Remcopal PONF, Remcopal 25, Remcopal 0.11, Remcopal 273, Tensagex DP24, Stepan agent 555-66A, Stepan agent 555-66B, Ethomeen T.25, Renex 650, Brij 72, Brij 78, and any other suitable emulsifying agents.

An FT oil/emulsifier (FT product oil plus emulsifying quantity of emulsifier) may thereafter be diluted with water (e.g. 20 to 160 gallons of water) to the FT oil/emulsifier composition (e.g. 1 quart) for application to vegetative fields. The quantity of pesticide/herbicide may be added prior to the dilution of the concentrated FT oil-emulsifying agent mixture with diluent, such as, for example, water. The application rate of the diluted emulsion plus pesticide/herbicide and the amount of pesticide/herbicide added will be in accordance with the particular requirements and characteristics of the pesticide/herbicide to be used. Like wettable powder formulations, concentrated liquid formulations may be diluted prior to application, for instance by the addition of the appropriate amount of water to provide a mixture having the desired concentration of active ingredient (pesticide/herbicide).

Alternatively, the pesticide/herbicide can be mixed with an emulsifier and an FT product and the mixture then diluted with water to the desired concentration. In addition, the pesticide/herbicide can be dissolved in a FT product solvent and afterwards mixed with an emulsifier. Such a mixture can likewise be diluted with water to the desired concentration. It is thus possible to obtain emulsifiable concentrates or ready-for-use emulsions.

The pesticidal formulation may be formulated for transport in a concentrated form which may subsequently be diluted by the user prior to application. In such embodiments, the pesticide formulation may further comprise a surfactant to facilitate this process of dilution. Thus, the liquid carrier in the formulations according to this disclosure may comprise a surfactant. For example, the liquid formulations may contain at least two or more carriers, at least one of which is a FT product.

Surfactants may be nonionic, anionic, cationic or zwitterionic substances with good dispersing, emulsifying and wetting properties depending on the nature of the pesticide compound. Surfactants may also mean mixtures of individual surfactants.

Water miscible cosolvents may be utilized in conjunction with the immiscible FT solvent to improve solubility of the pesticide/herbicide. Commonly used solvents such as petroleum-derived toluene, xylene, chlorotoluene, benzene, methyl isobutyl ketone, cyclohexanone, naphtha and the like may be replaced with FT hydrocarbons such as FT naphtha, FT diesel, etc.

The pesticide/herbicide formulation may be used in combination with other pesticides/herbicides in order to achieve the range and specificity of weed control/pest control desired. A typical method for employing a combination of pesticides/herbicides and another herbicide/pesticide, comprises mixing and diluting the individual formulations of the respective individual herbicides/pesticides just prior to application. The mixing can be carried out, for example, in the tank of a conventional spraying apparatus. The pesticide formulations of this disclosure may be used in conjunction with conventional formulations comprising petroleum-derived solvents and/or carriers.

Other Ingredients. In addition to the above-mentioned components, the formulations of the present invention may include other ingredients commonly employed in the art. Examples of such ingredients include drift control agents, defoaming agents, preservatives, surfactants, fertilizers, phytotoxicants, adherents, trace elements, synergists, intidotes, corrosion inhibitors, stabilizers, penetrants, retention enhancers (stickers), dispersants, emulsifiers, certain organic solids or inorganic salts dissolved in the formulation to assist in preventing sedimentation and crystallization or as antifreeze agents for water mixtures thereof, and other such adjuvants well known in the art.

Inert ingredients may be added to the formulation at the same time or in a separate impregnation step occurring before or after the solution of pesticide/herbicide in FT product is impregnated onto a solid carrier or in multiple impregnation steps occurring before, at the same time, and/or after the pesticide/herbicide is impregnated onto the carrier. Similarly, inert ingredients may be added before, with, or after the combination of the pesticide with the FT product liquid carrier. This invention also contemplates compositions which include one or more additional pesticides and/or one or more fertilizing materials. Fertilizing materials may function as the carrier, may be impregnated onto the carrier, or be separately added to the formulation.

Method of Use. The invention further includes a method of inhibiting growth of weeds and/or pests which method comprises applying the formulation in concentrated or diluted form to a locus in which it is desired to inhibit the growth of weeds and/or the presence of pests.

The formulation may be applied as a spray or the like by conventional spraying, dusting, drenching, scattering, and other agricultural chemical application methods.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. Accordingly, the scope of protection is not limited to the embodiments described herein, but is only limited by the claims which follow, the scope of which shall include all equivalents of the subject matter of the claims.

What is claimed is:

1. A pesticide or herbicide formulation comprising an effective amount of a pesticide or herbicide in a carrier or solvent fluid, said carrier or solvent fluid comprising a Fischer-Tropsch hydrocarbon produced via Fischer-Tropsch conversion of synthesis gas.

2. The formulation of claim 1 wherein the pesticide or herbicide is an agricultural formulation.

3. The formulation of claim 1 wherein the pesticide or herbicide is an oil-soluble pesticide or herbicide.

4. The formulation of claim 1 wherein the formulation is a concentrated form.

5. The formulation of claim 1 comprising an inert solid carrier impregnated with a solution comprising the pesticide or herbicide and the FT hydrocarbon.

6. The formulation of claim 5 wherein the solid carrier is selected from the group consisting of ground natural minerals, ground synthetic minerals, synthetic granules of inorganic and organic meals, granules of organic material, synthetic polymeric materials, and combinations thereof.

7. The formulation of claim 1 wherein the formulation is in the form of an emulsifiable concentrate, and wherein the formulation comprises the effective amount of the pesticide or herbicide in FT hydrocarbon liquid carrier, and wherein the formulation further comprises an emulsifier.

8. The formulation of claim 7 wherein the emulsifier is selected from the group consisting of surfactants.

9. The formulation of claim 1 wherein the FT hydrocarbon comprises FT naphtha, FT diesel, FT kerosene or a combination thereof.

10. The formulation of claim 1 wherein the Fischer-Tropsch hydrocarbon was produced with a precipitated iron catalyst comprising a weight ratio of potassium to iron in the range of from about 0.005 and about 0.015 and a weight ratio of copper to iron in the range of from about 0.005 and about 0.05.

11. The formulation of claim 10 wherein the Fischer-Tropsch catalyst further comprises a structural promoter.

12. The formulation of claim 11 wherein the structural promoter comprises silica.

13. A method of producing a pesticide or herbicide formulation, the method comprising:
combining an amount of an herbicide or pesticide and a biodegradable solvent to form a pesticide or herbicide solution.

14. The method of claim 13 wherein the biodegradable solvent is a product of Fischer-Tropsch conversion of synthesis gas.

15. The method of claim 14 wherein the biodegradable solvent comprises Fischer-Tropsch diesel.

16. The method of claim 14 wherein the biodegradable solvent comprises Fischer-Tropsch naphtha.

17. The method of claim 16 wherein the biodegradable solvent comprises Fischer-Tropsch kerosene.

18. The method of claim 14 wherein the biodegradable solvent is a product of Fischer-Tropsch conversion of synthesis gas in the presence of a precipitated iron catalyst.

19. The method of claim 18 wherein the precipitated iron catalyst comprises a weight ratio of potassium to iron in the range of from about 0.005 and about 0.015 and a weight ratio of copper to iron in the range of from about 0.005 and about 0.05.

20. The method of claim 13 further comprising impregnating a solid carrier with the solution.

21. The method of claim 20 wherein the solid carrier is selected from the group consisting of ground natural minerals, ground synthetic minerals, synthetic granules of inorganic and organic meals, granules of organic material, synthetic polymeric materials, and combinations thereof.

22. The method of claim 13 wherein the amount of pesticide or herbicide is a concentrated amount and wherein the solution further comprises an emulsifier, wherein the concentrated amount is an amount greater than an effective application amount of the pesticide or the herbicide.

23. The method of claim 22 wherein the emulsifier is selected from the group consisting of surfactants.

24. A method of producing a pesticide or herbicide formulation, the method comprising:
converting synthesis gas into Fischer-Tropsch products in the presence of a Fischer-Tropsch catalyst; and
combining at least one Fischer-Tropsch product with a pesticide or herbicide to create the formulation.

25. The method of claim 24 wherein the FT catalyst is a precipitated iron catalyst comprising a weight ratio of potassium to iron in the range of from about 0.005 and about 0.015 and a weight ratio of copper to iron in the range of from about 0.005 and about 0.05.

26. The method of claim 25 wherein the iron catalyst further comprises a structural promoter.

27. The method of claim 26 wherein the structural promoter comprises silica.

28. The method of claim 26 wherein the Fischer-Tropsch catalyst is a cobalt catalyst.

29. The method of claim 24 further comprising upgrading the Fischer-Tropsch products.

30. The method of claim 24 wherein the at least one Fischer-Tropsch product comprises naphtha, diesel, kerosene, or a combination thereof.
